(19) United States
(12) Patent Application Publication
(10) Pub. No.: US 2025/0388382 A1
(43) Pub. Date: Dec. 25, 2025

(54) DIAPHRAGM MOUTH CALL STORAGE CONTAINER WITH HUMIDITY CONTROL AND ADJUSTABLE POSITIONING SYSTEM

(71) Applicant: Salk River Outdoors, LLC, Islandton, SC (US)

(72) Inventors: Joshua Jones, Islandton, SC (US); Kevin Hazel, Islandton, SC (US); James Ayer, Islandton, SC (US)

(21) Appl. No.: 19/244,638

(22) Filed: Jun. 20, 2025

Related U.S. Application Data
(60) Provisional application No. 63/664,179, filed on Jun. 25, 2024.

(51) Int. Cl. B65D 81/26; A01M 31/00

(52) U.S. Cl. CPC B65D 81/263; B65D 81/264; A01M 31/004

(57) ABSTRACT

A container for storing diaphragm mouth calls may include a body having an internal cavity configured to enclose one or more diaphragm mouth calls. A moisture control system may be integrated within the body, the moisture control system may comprise a moisture-retaining component and a plurality of adjustable airflow vents. A magnetic securing system may be within the body, the magnetic securing system may comprise a magnetic plate configured to secure the diaphragm mouth calls in position. The moisture-retaining component may comprise a replaceable moisture pad impregnated with antimicrobial agents to prevent growth of mold and bacteria. The magnetic plate may comprise multiple magnetic zones of varying magnetic strengths, configured to accommodate diaphragm mouth calls of different sizes and weights. The adjustable airflow vents may be operable from the exterior of the container and may include filters to prevent ingress of dust and particulate matter.

### RELATED APPLICATION

Under provisions of 35 U.S.C. § 119(e), the Applicant claims benefit of U.S. Provisional Application No. 63/664,179 filed on Jun. 25, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to humidity-controlled storage containers for hunting equipment, and more particularly to containers for storing and preserving diaphragm mouth calls with adjustable positioning systems for controlling moisture exposure.

### BACKGROUND

Diaphragm mouth calls are widely used in hunting, particularly for attracting game animals by mimicking their sounds. These calls typically consist of thin latex or rubber membranes stretched over frames that hunters place in their mouths to produce animal sounds. Proper storage of these calls is critical for maintaining their functionality and longevity.

Conventional storage systems for diaphragm mouth calls generally consist of basic plastic containers or cases with minimal features. These standard containers often lack specialized design elements for the preservation of the delicate latex or rubber membranes. Many hunters resort to using generic plastic cases, pill containers, or even plastic bags for storing their calls.

Traditional storage containers frequently fail to address the specific environmental requirements necessary for preserving diaphragm mouth calls. Without proper humidity control, the latex or rubber membranes can become damaged. Excessive dryness causes the membranes to crack and lose elasticity, while excessive moisture promotes mold and bacterial growth. Both conditions significantly reduce the effectiveness and lifespan of the calls.

Standard storage solutions typically do not provide organizational features to accommodate multiple calls. Hunters often own several different calls, each producing distinct sounds for various hunting scenarios. When stored together without proper organization, the calls can become tangled or damaged through contact with each other.

Transportation of diaphragm mouth calls presents additional challenges. Conventional containers are rarely designed with portability in mind. They may be bulky, difficult to carry, or prone to opening unexpectedly during transport. This can result in calls being exposed to environmental elements or becoming lost.

The positioning of calls within conventional storage containers is generally fixed, with calls typically placed directly on the bottom surface or in basic compartments. This arrangement does not allow for customization based on the specific needs of different call types or varying environmental conditions.

Many existing storage solutions are constructed from materials that may not be durable enough to withstand the rigors of outdoor use. They can crack or break when exposed to temperature fluctuations or when dropped, leaving the calls vulnerable to damage.

Furthermore, conventional storage containers rarely incorporate antimicrobial properties, which can be important for items that are placed in the mouth. Without such protection, calls may harbor bacteria or mold, potentially creating health concerns for the user.

The maintenance of proper humidity levels for diaphragm mouth calls is particularly challenging in various hunting environments. In arid regions, the lack of ambient moisture can rapidly degrade the latex or rubber membranes, causing them to lose elasticity and develop cracks. These cracks alter the sound quality and ultimately render the calls unusable. Hunters in these regions must find ways to maintain adequate moisture levels for their calls despite the dry conditions. Conversely, in humid environments, excessive moisture can lead to mold and bacterial growth on the calls. This not only damages the calls but also creates potential health hazards when the calls are placed in the mouth. Traditional storage solutions rarely address these region-specific challenges, forcing hunters to improvise with makeshift humidity control methods that are often inconsistent and ineffective.

Temperature fluctuations present another significant challenge for diaphragm mouth call preservation. Extreme heat can cause the latex or rubber membranes to warp or deform, while freezing temperatures can make them brittle and prone to tearing. Standard storage containers provide minimal insulation against these temperature variations, leaving the calls vulnerable to damage during seasonal changes or when transported between different climate zones.

Long-term storage between hunting seasons introduces additional complications. Without proper storage systems, calls may deteriorate during the off-season, requiring replacement before the next hunting season begins. This represents both a financial burden for hunters and an environmental concern due to increased waste from discarded calls.

Hygiene considerations are also inadequately addressed by conventional storage solutions. Diaphragm mouth calls are placed directly in the mouth during use, making proper cleaning and sanitary storage essential. However, standard containers often lack features that facilitate cleaning or prevent bacterial contamination, potentially leading to oral health issues for hunters.

The organizational needs of professional guides and competitive hunters are particularly underserved by traditional storage options. These individuals often require immediate access to specific calls for different game scenarios or competition requirements. Without proper organizational systems, they may experience delays in locating the appropriate call, potentially missing critical hunting opportunities.

For hunters who travel frequently, the lack of portable, secure storage solutions creates additional challenges. Conventional containers may be too bulky for travel or may not provide adequate protection against the rigors of transportation. This can result in damaged or lost calls, disrupting carefully planned hunting expeditions.

The limitations of existing diaphragm mouth call storage solutions highlight the need for improved designs that address the specific requirements of these specialized hunting tools. Current options fail to provide the combination of humidity control, organization, portability, and protection necessary for maintaining the functionality and extending the lifespan of diaphragm mouth calls.

Several specific commercial products exemplify the limitations of current diaphragm mouth call storage solutions. A basic call case is a common plastic container sold by many hunting supply retailers. This basic case provides minimal protection with a simple hinged design that offers no humidity control or organization features. Similarly, a multi-call plastic box provides basic compartmentalization but lacks any moisture regulation capabilities, leaving calls vulnerable to environmental damage.

Some manufacturers have attempted to address humidity concerns through rudimentary solutions such as dampened storage cases, which include a small sponge that requires manual wetting. This approach is problematic, as it provides inconsistent humidity levels-often too wet initially and then quickly drying out. The moisture distribution is also uneven, potentially over-exposing some calls while under-exposing others.

Several premium hunting brands offer higher-end call carriers featuring multiple compartments and durable construction. However, even these higher-end solutions typically fail to incorporate humidity control systems. Their rigid compartment designs also prevent customization based on the varying needs of different call types.

Pocket call holders emphasize portability but sacrifices protection and organization. These minimalist designs often expose calls to pocket lint, moisture from perspiration, and physical stress from body movement during hunting activities. The lack of structure can result in bent frames or torn reeds.

For hunters who use multiple calls, a call collection case offers numerous fixed compartments. However, the standardized spacing does not account for the varying dimensions of different call models. Additionally, these cases lack features to prevent calls from moving within their compartments during transport, leading to potential damage from contact between calls.

The inadequacies of existing storage solutions are particularly evident in the field. Hunters often report premature deterioration of their diaphragm mouth calls due to improper storage conditions. The latex or rubber membranes frequently develop cracks from dryness or become contaminated with mold from excess moisture. These issues not only reduce the effectiveness of the calls but also necessitate frequent replacements, creating additional expenses for hunters.

Furthermore, the organizational limitations of current storage options result in inefficiency during hunting. When multiple calls are stored together without proper organization, hunters waste valuable time searching for specific calls. This can be particularly problematic during time-sensitive hunting situations where quick access to the appropriate call is crucial.

The portability challenges of existing containers further compound these issues. Many hunters report that current storage solutions are either too bulky to carry conveniently or too flimsy to provide adequate protection in the field. This forces hunters to choose between the inconvenience of carrying bulky containers or risking damage to their calls by using inadequate storage options.

The lack of antimicrobial properties in conventional storage solutions also presents health concerns. Diaphragm mouth calls are placed directly in the mouth during use, and without proper antimicrobial protection, they can harbor harmful bacteria or mold. This is especially problematic for calls that are stored in humid conditions, which promote microbial growth.

These limitations highlight the gap in the market for a specialized storage solution that addresses the unique preservation needs of diaphragm mouth calls. An effective storage system would need to incorporate humidity control, organizational features, portability, and antimicrobial properties to properly maintain these delicate hunting tools.

The need for an effective diaphragm mouth call storage solution is particularly acute due to the significant financial investment hunters make in these specialized tools. High-quality diaphragm calls can cost between $10-30 each, with serious hunters often owning collections of 10-20 different calls. When these calls deteriorate prematurely due to improper storage, hunters face substantial replacement costs that could be avoided with appropriate preservation methods. Additionally, the unpredictable nature of hunting opportunities means that hunters need their calls to be in optimal condition whenever a hunting situation arises. Without reliable storage solutions, hunters may find themselves with damaged or ineffective calls at critical moments, potentially ruining hunting experiences that required significant preparation and travel. These challenges are compounded by the fact that the materials used in diaphragm mouth calls—primarily thin latex membranes—are inherently vulnerable to environmental factors, making proper storage not merely a convenience but a necessity for maintaining their functionality and extending their usable lifespan.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A container for storing diaphragm mouth calls may comprise a body having an internal cavity configured to enclose one or more diaphragm mouth calls. The container may include a moisture control system integrated within the body. The moisture control system may comprise a moisture-retaining component and a plurality of adjustable airflow vents. The container may include a magnetic securing system within the body. The magnetic securing system may comprise a magnetic plate configured to secure the diaphragm mouth calls in position.

A system for storing and preserving diaphragm mouth calls may comprise a container body having an internal cavity configured to enclose one or more diaphragm mouth calls. The system may include a humidity regulation subsystem comprising a moisture-retaining component housed within the container body and configured to maintain a predetermined humidity level inside the container body. The system may include a positioning subsystem within the container body configured to secure the diaphragm mouth calls in multiple positions relative to the moisture-retaining component.

A container for storing diaphragm mouth calls may comprise a body configured to enclose one or more diaphragm mouth calls. The container may include a moisture-retaining component positioned within the body. The moisture-retaining component may comprise a hydrogel formulated to maintain a predetermined humidity level inside the container. The container may include a tiered positioning system within the body. The tiered positioning system may comprise multiple vertically arranged platforms configured to hold diaphragm mouth calls at different heights relative to the moisture-retaining component. The container may include a magnetic securing mechanism integrated into each platform of the tiered positioning system to hold the diaphragm mouth calls in place.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a perspective view of a container for storing and preserving diaphragm mouth calls consistent with the present disclosure;

FIG. 2 illustrates a sectional view of the container for storing and preserving diaphragm mouth calls;

FIG. 3 illustrates an exploded view of the container for storing and preserving diaphragm mouth calls; and

FIG. 4 is a flow chart of a method for using the containers for storing and preserving diaphragm mouth calls.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The technical problem addressed by the present disclosure relates to the preservation and storage of diaphragm mouth calls used in hunting activities. Diaphragm mouth calls may be susceptible to damage when exposed to environmental elements, particularly varying moisture levels. Improper storage conditions may lead to significant issues affecting the functionality and longevity of these specialized tools.

In some scenarios, excessive moisture exposure may promote the growth of unwanted microorganisms such as mold and bacteria on diaphragm mouth calls. This microbial growth may not only damage the physical structure of the calls but may also pose potential health risks to users who place these calls in their mouths. Conversely, insufficient moisture may lead to material degradation, causing the calls to become brittle, crack, or lose their elasticity and proper resonance characteristics. These conditions may render the calls ineffective for their intended purpose in hunting scenarios.

Standard storage containers may not offer adequate protection against these varying moisture levels. Many conventional storage solutions may lack the ability to maintain optimal humidity conditions necessary for preserving diaphragm mouth calls. Users may find that their calls deteriorate over time despite being stored in what might appear to be protective enclosures. The lack of humidity control features in traditional containers may result in calls that are either too dry and prone to cracking or too moist and susceptible to mold growth.

Furthermore, organization of multiple diaphragm mouth calls for ease of access and efficiency may be overlooked in standard storage solutions. Without proper organizational features, calls may become disorganized, potentially leading to physical damage when users attempt to locate specific calls. The absence of secure positioning systems may allow calls to shift during transport, increasing the risk of deformation or other physical damage.

The challenge of achieving and maintaining specific humidity levels crucial for keeping calls in ready-to-use condition may prove difficult with traditional storage methods. Users may resort to makeshift solutions such as placing damp paper towels or sponges in containers, which may provide inconsistent results and potentially introduce excess moisture that promotes mold growth rather than preservation.

For hunters who frequently move between locations, the need for storage solutions that are easy to transport may be paramount. Many existing storage options may not prioritize portability or compatibility with vehicles, making it inconvenient for users to maintain proper storage conditions while traveling to hunting locations. Containers that are cumbersome or unwieldy may discourage regular use, thereby compromising the condition of the diaphragm mouth calls during transit.

Additionally, ensuring the security of valuable diaphragm mouth calls to prevent potential loss or unauthorized use may remain inadequately addressed by many available storage options. Without proper securing mechanisms, calls may be subject to theft or tampering, leading to financial loss or compromised performance when needed.

The environmental impact of manufacturing and disposing of storage containers may also be a critical consideration for environmentally conscious consumers. Many conventional storage solutions may utilize materials and manufacturing processes that are not aligned with sustainable practices, creating tension between the need for effective storage and environmental responsibility.

In the context of hunting activities, the consequences of improperly preserved diaphragm mouth calls may be particularly significant. For example, a hunter who has traveled to a remote location for a planned hunting expedition may discover that their calls have become damaged due to improper storage during transport. The calls may have dried out from exposure to the heating system in the vehicle, rendering them brittle and ineffective. Alternatively, calls stored in a container without adequate moisture control may have developed mold during transport through humid environments, making them unusable and potentially harmful.

In another scenario, a hunter attempting to organize multiple diaphragm mouth calls of varying types for different game animals may struggle with standard storage containers that lack organizational features. Without proper compartmentalization or securing mechanisms, the calls may become mixed together, making it difficult to quickly identify and access the appropriate call for a specific hunting situation. This disorganization may lead to missed opportunities when rapid call selection is necessary.

The challenge of maintaining optimal humidity levels may be further complicated by seasonal and geographical variations. A hunter who uses diaphragm mouth calls in different regions with varying climate conditions may find that a storage solution that works well in one environment fails to provide adequate protection in another. For instance, a container that maintains appropriate humidity in a moderate climate may not prevent excessive drying in arid conditions or excessive moisture accumulation in humid environments.

For competitive callers who rely on precisely tuned diaphragm mouth calls for competitions, the consequences of improper storage may be particularly severe. These specialized calls may require exact moisture levels to maintain their specific tonal qualities. Standard storage solutions may fail to provide the precise humidity control necessary for maintaining these finely tuned instruments, potentially affecting competition performance and outcomes.

These scenarios illustrate the multifaceted nature of the technical problem being addressed by the present disclosure. The challenges of preserving diaphragm mouth calls extend beyond simple protection from physical damage to include considerations of humidity control, organization, portability, security, and environmental sustainability. The container described in the present disclosure may address these challenges through its specialized design features, providing a comprehensive solution for the storage and preservation of diaphragm mouth calls across varying scenarios and usage contexts.

The container for storing diaphragm mouth calls with humidity control and adjustable positioning system described herein offers numerous technical advantages over prior art storage solutions. The integrated moisture control system with adjustable airflow vents and replaceable moisture pads may provide precise regulation of internal humidity levels, which may be critical for maintaining the optimal condition of diaphragm mouth calls. Unlike conventional storage containers that lack humidity management capabilities, this system may allow users to create and sustain the specific moisture environment required for preserving the elasticity, resonance, and overall functionality of these specialized hunting tools.

The magnetic securing system within the container may offer significant advantages over traditional storage methods by firmly holding diaphragm mouth calls in fixed positions. This magnetic system with multiple zones of varying strengths may prevent unwanted movement during transport, reducing the risk of physical damage that commonly occurs in conventional containers where calls may shift and collide. The non-magnetic barrier layer between the magnetic plate and the calls may further protect the integrity of the calls by preventing direct contact with the magnetic surface, which could otherwise potentially alter their delicate structures.

The customizable positioning system with adjustable compartments and elevated platforms may provide unprecedented flexibility in how diaphragm mouth calls are stored relative to the moisture source. This feature may allow users to precisely control the level of moisture exposure for each individual call, addressing the varied humidity requirements of different call types and materials. Standard containers typically offer uniform environments that may be unsuitable for collections containing diverse call varieties, whereas this system may enable micro-environmental customization within a single container.

The inclusion of a hygrometer visible through a viewing window may deliver significant technical benefits by enabling real-time monitoring of internal humidity conditions without opening the container. This feature may allow users to verify optimal preservation conditions without disrupting the controlled environment, preventing the humidity fluctuations that commonly occur when conventional containers are repeatedly opened for inspection. The transparent viewing window may also reduce unnecessary handling of the calls, further protecting them from potential damage.

The replaceable moisture pad system with antimicrobial properties may provide substantial technical advantages in preventing the growth of mold and bacteria on stored diaphragm mouth calls. This feature may address a critical failure point in traditional storage solutions, where moisture management often inadvertently creates conditions favorable for microbial growth. The antimicrobial properties may ensure that the humidity necessary for call preservation does not simultaneously create health risks for users who place these calls in their mouths.

The container's airtight sealing capability may offer important technical benefits by isolating the internal environment from external conditions. This feature may maintain consistent humidity levels regardless of ambient environmental changes, addressing the problem of humidity fluctuations that occur in conventional containers when exposed to varying climate conditions. The sealing mechanism may also prevent contamination from dust, dirt, and other particulates that could degrade call performance.

The container's construction from high-impact resistant polymer with UV protection additives may offer technical advantages through enhanced durability and longevity in outdoor environments. This material composition may protect the container and its contents from environmental stresses such as impacts, moisture, and temperature variations, addressing the vulnerability of conventional containers to damage from rough handling or exposure to elements during hunting activities.

The interior surfaces coated with non-toxic, anti-microbial layers may provide significant technical benefits by creating a hygienic environment for storing items that contact the user's mouth. This feature may prevent the colonization of harmful microorganisms on the container surfaces that could transfer to the calls, addressing health concerns associated with conventional storage solutions that lack antimicrobial properties.

The container's collapsible design may provide technical benefits through space efficiency when not in use. This feature may reduce the storage footprint required for the container during off-seasons or between hunting trips, addressing the bulkiness of conventional rigid containers that occupy the same amount of space regardless of whether they contain calls. The present disclosure includes many aspects and features. Moreover, while many aspects and features relate to, and are described in, the context of a container for storing diaphragm mouth calls with humidity control and adjustable positioning system, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The container for storing diaphragm mouth calls with humidity control and adjustable positioning system may provide a specialized solution for preserving and maintaining these hunting tools in optimal condition. The container may address the critical challenges faced by hunters and outdoor enthusiasts who rely on diaphragm mouth calls for their activities.

The container may function as a protective enclosure for diaphragm mouth calls while incorporating advanced features for humidity regulation and customizable positioning. The body of the container may be constructed from durable materials that can withstand the rigors of outdoor use while maintaining an internal environment conducive to call preservation.

The moisture control system may represent a fundamental aspect of the container's functionality. This system may include replaceable moisture pads that can be impregnated with antimicrobial agents to prevent mold and bacteria growth. The moisture pads may work in conjunction with adjustable airflow vents that can allow users to regulate the humidity levels within the container. A hygrometer visible through a viewing window may enable users to monitor internal conditions without opening the container, thereby maintaining the controlled environment.

The magnetic securing system may provide a means to hold diaphragm mouth calls firmly in place during transport and storage. This system may include a magnetic plate with multiple zones of varying strengths to accommodate calls of different sizes and weights. A non-magnetic barrier layer may be positioned between the calls and the magnetic surface to prevent potential damage to the delicate structures of the calls.

The adjustable positioning system may offer unprecedented flexibility in how diaphragm mouth calls are stored relative to the moisture source. Users may be able to place calls at various distances from the moisture-retaining component, allowing for precise control over the level of moisture exposure for each individual call. This feature may be particularly valuable for collections containing diverse call varieties with different humidity requirements.

The container may incorporate practical features for everyday use, such as a base designed to fit in standard vehicle cup holders and a transparent viewing window for content inspection without opening the container. The interior may be designed with customizable compartments and dividers to organize multiple calls efficiently.

For hunters who frequently move between locations with varying climate conditions, the container's ability to maintain a consistent internal environment regardless of external conditions may be especially valuable. The airtight sealing capability may isolate the interior from environmental fluctuations, while the durable construction may protect against physical damage during transport.

This specialized container may transform the way diaphragm mouth calls are stored and preserved, extending their lifespan and ensuring they remain in ready-to-use condition whenever needed. By addressing the multifaceted challenges of moisture control, organization, portability, and protection, the container may provide a comprehensive solution for hunters and outdoor enthusiasts who rely on these specialized tools.

Embodiments of the present disclosure may comprise modules such as, but not limited to, one or more of the following:
A. A Reed Holder
B. A Reed Container
C. A Sealing Lid
D. A Reed Tray
E. A Cleaning Solution Cup
F. A Storage Cup

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

The container may be used for storing diaphragm mouth calls with humidity control and adjustable positioning system. The container may operate in a variety of environments that present different challenges for preserving these specialized hunting tools. The operating environment may span from home storage locations to outdoor hunting settings, with each environment potentially introducing distinct conditions that may affect the functionality and longevity of diaphragm mouth calls.

In a home storage environment, the container may be exposed to varying indoor climate conditions. Residential heating and cooling systems may create fluctuations in ambient temperature and humidity levels that could potentially affect the diaphragm mouth calls if not properly isolated. The container may be designed to function effectively in temperature ranges typically found in residential settings, which may range from approximately 60° F. to 80° F. (15° C. to 27° C.). The humidity control system integrated within the container may maintain appropriate internal moisture levels regardless of whether the home environment may be artificially dry due to heating systems or excessively humid due to regional climate conditions.

During transportation to hunting locations, the container may be subjected to more variable conditions. The container may be carried in vehicles where temperature fluctuations may be significant, particularly in seasonal extremes. Vehicle interiors may reach temperatures well above 100° F. (38° C.) in summer months or drop below freezing in winter. The container's construction materials may be selected to withstand these temperature variations without compromising the internal environment. The moisture control system may continue to function effectively despite these external temperature changes, maintaining the optimal humidity level for the diaphragm mouth calls.

The base portion of the container dimensioned to fit within standard vehicle cup holders may provide stability during transport. This feature may prevent the container from shifting or tipping during vehicle movement, which could potentially disrupt the positioning of the calls or damage them. The anti-vibration features incorporated into the base may minimize the effects of road vibrations that could otherwise cause the calls to shift or become damaged during transit.

In field environments, the container may be exposed to outdoor elements including direct sunlight, precipitation, dust, and varying humidity levels. The high-impact resistant polymer used in the construction of the container may provide protection against physical impacts that may occur during outdoor activities. The UV protection additives in the material may prevent degradation from sunlight exposure, which may be particularly relevant when the container may be used or stored in open field conditions during hunting expeditions.

The waterproof and impact-resistant exterior of the container may shield the contents from rain, snow, or accidental submersion that may occur in field environments. This protection may be essential for preserving the diaphragm mouth calls, which may be sensitive to moisture infiltration beyond the controlled levels maintained by the internal humidity system.

The container may also be designed to operate effectively in a wide range of geographic and seasonal conditions. Hunters may travel to diverse locations with varying climate characteristics, from arid desert environments to humid swamplands. The airtight sealing capability of the container may isolate the internal environment from these external conditions, ensuring that the diaphragm mouth calls may remain in optimal condition regardless of the ambient environment.

In extremely dry environments, the moisture-retaining component within the container may release humidity to prevent the diaphragm mouth calls from becoming brittle or cracking. Conversely, in highly humid environments, the hygroscopic material may absorb excess moisture to prevent mold growth or material degradation. This bidirectional moisture control may be essential for maintaining the elastic properties and resonance characteristics of the calls across diverse environmental conditions.

The operating environment of the container may also include storage situations where space efficiency may be a consideration. The collapsible design feature may allow the container to be compacted when not in use, which may be beneficial in hunting cabins, vehicles, or other locations where storage space may be limited. This feature may enhance the practicality of the container in real-world usage scenarios.

The magnetic securing system within the container may maintain the diaphragm mouth calls in fixed positions during transport over rough terrain, which may be common in hunting environments. This stability may prevent damage that could otherwise occur from calls shifting and colliding during movement through challenging outdoor conditions.

The interior surfaces may be coated with one or more non-toxic, anti-microbial layers. These layers may create a hygienic environment for storing items that contact the user's mouth. This feature may be especially important in field conditions where general cleanliness may be more difficult to maintain and where calls may be frequently handled and used.

For hunters who travel between regions with significantly different climate conditions, the container's ability to maintain consistent internal humidity levels regardless of external environment may be particularly valuable. The airtight sealing capability may isolate the interior from environmental fluctuations, while the moisture control system may actively regulate the humidity to keep the calls in optimal condition.

The adjustable airflow vents may allow users to fine-tune the internal environment based on specific external conditions. In extremely dry or humid environments, users may adjust the vents to increase or decrease the rate of moisture exchange, providing an additional level of control over the preservation conditions.

The container may rely on specific infrastructure elements to support its functionality across various usage scenarios. While the container may be designed to operate largely as a self-contained unit, certain infrastructure considerations may enhance its effectiveness and user experience.

The container may include a moisture control system integrated within the container. The moisture control system may require periodic maintenance to ensure continued functionality. Users may need access to replacement moisture pads and/or other components that can be easily obtained through retail channels or online ordering systems. The design of the container may account for this by incorporating easily accessible compartments for these replaceable elements, allowing users to perform maintenance without specialized tools or technical expertise.

The replaceable moisture pads may be impregnated with antimicrobial agents. The pads may be manufactured to standardized dimensions specific to the container model. This standardization may ensure compatibility and optimal performance when replacements are needed. The manufacturing and distribution infrastructure for these consumable components may be essential to the long-term utility of the container.

For users who frequently transport the container in vehicles, the infrastructure of standard vehicle cup holders may be leveraged. The base portion of the container may be specifically dimensioned to fit within these standardized receptacles, providing stability during transit. The anti-vibration features in the base may work in conjunction with the vehicle's cup holder to minimize movement and potential damage to the contained diaphragm mouth calls.

In some embodiments, the container may incorporate a transparent viewing window and integrated hygrometer, which may provide real-time humidity monitoring capabilities without requiring the container to be opened. This self-contained monitoring infrastructure may reduce the need for external humidity measurement tools, simplifying the user experience while maintaining the integrity of the controlled internal environment.

The container may include a magnetic securing system. The magnetic securing system may utilize multiple zones of varying magnetic strengths to accommodate diaphragm mouth calls of different sizes and weights. The manufacturing infrastructure required to produce these precisely calibrated magnetic components may involve specialized equipment and quality control processes to ensure consistent performance across all produced units.

The high-impact resistant polymer used in the construction of the container body may be selected for its durability and resistance to environmental stressors. The polymer formulation may include UV protection additives to prevent degradation from sunlight exposure. The manufacturing infrastructure for producing these specialized materials may involve chemical engineering processes and quality testing to verify the material properties meet the required specifications.

The non-toxic, anti-microbial coating applied to the interior surfaces of the container may require specific application techniques during manufacturing. This coating may be critical for preventing the growth of mold and bacteria on surfaces that may come into contact with the diaphragm mouth calls, which are placed in the user's mouth during use. The infrastructure for applying and curing these coatings may involve specialized equipment and controlled manufacturing environments.

The adjustable airflow vents integrated into the container design may require precision engineering to ensure smooth operation and effective control of air exchange. These vents may include filters to prevent the ingress of dust and particulate matter while allowing moisture regulation. The manufacturing infrastructure for these components may involve micro-precision tooling and assembly processes.

For users who require secure storage, the container may incorporate locking mechanisms accessible from the exterior. These security features may range from simple mechanical locks to more advanced electronic or biometric systems in premium models. The infrastructure for producing and supporting these security components may include specialized manufacturing processes and, for electronic systems, firmware development and maintenance.

The modular interior components designed for organizing and storing diaphragm mouth calls and related accessories may be produced using injection molding processes. The infrastructure for manufacturing these components may include precision molds, quality control systems, and assembly processes to ensure proper fit and function within the container.

The container for storing diaphragm mouth calls with humidity control and adjustable positioning system may incorporate various hardware components to enable its functionality across different operating environments. These hardware components may be essential for ensuring the container's effectiveness in preserving diaphragm mouth calls while providing users with the control and flexibility needed for optimal call maintenance.

The body of the container may be constructed from lightweight durable materials. As a non-limiting example, the body may be formed from high-impact resistant polymer materials such as high-density polyethylene (HDPE), acrylonitrile butadiene styrene (ABS), and/or polycarbonate. These materials may provide the necessary durability to withstand impacts, moisture exposure, and temperature variations commonly encountered in hunting environments. The polymer formulation may include UV stabilizers to prevent degradation from prolonged sunlight exposure, which may be particularly relevant when the container may be used or stored in outdoor settings. The wall thickness of the container body may range from approximately 2 mm to 5 mm, providing sufficient structural integrity while maintaining a lightweight profile for portability.

The moisture control system may incorporate several hardware components working in conjunction to maintain optimal humidity levels. The replaceable moisture pads may be composed of hydrophilic materials such as silica gel, polyacrylamide, or natural cellulose fibers impregnated with antimicrobial agents. These pads may be housed in a dedicated compartment within the container, which may feature a removable tray or cartridge design for easy replacement. The moisture pad housing may be constructed from a non-reactive plastic such as polypropylene to prevent any chemical interaction with the moisture-retaining materials.

The adjustable airflow vents integrated into the container walls may consist of rotating or sliding mechanisms that can be manipulated from the exterior of the container. These vents may include micro-perforated screens or filters with pore sizes ranging from 20 to 100 microns to prevent the ingress of dust and particulate matter while allowing controlled air exchange. The vent mechanisms may incorporate silicone or rubber gaskets to ensure an airtight seal when in the closed position, preventing unintended moisture loss or gain.

In some embodiments, a hygrometer may be visible through a viewing window. The hygrometer may utilize analog and/or digital technology to provide accurate humidity readings. An analog hygrometer may employ a moisture-sensitive material that expands or contracts based on ambient humidity, mechanically moving an indicator needle across a calibrated scale. A digital hygrometer may incorporate a capacitive or resistive humidity sensor connected to a small LCD display, potentially powered by a button cell battery with a lifespan of 1-3 years under normal usage conditions. The accuracy of the hygrometer may be, as a non-limiting example, within +3% relative humidity to help ensure reliable monitoring of internal conditions.

The magnetic securing system may utilize permanent magnets, such as neodymium magnets, embedded within a plate or board positioned in the base of the container. These magnets may have varying strengths. As a non-limiting example, the strengths may range from approximately 0.5 to 2 tesla, to accommodate diaphragm mouth calls of different sizes and/or weights. The magnetic plate may be covered with a non-magnetic barrier layer formed from biocompatible materials such as food-grade silicone, polyethylene, and/or similar non-reactive materials to prevent direct contact between the magnets and the diaphragm mouth calls. This barrier may be, as a non-limiting example, approximately 0.5 mm to 1 mm thick, providing sufficient separation while maintaining effective magnetic attraction.

The positioning system within the container may include one or more adjustable platforms, dividers, or compartments that can be reconfigured based on user preferences. These components may be constructed from the same polymer materials as the container body, and/or from lightweight alternatives such as expanded polypropylene (EPP) or ethylene-vinyl acetate (EVA) foam. The adjustable platforms may incorporate locking mechanisms such as snap-fit tabs, friction-fit slots, or threaded adjusters to maintain their position once set. The height adjustment range for these platforms may span from near-contact with the moisture source to approximately 50 mm above it, allowing for precise control over moisture exposure.

The sealing mechanism of the container may utilize a silicone, EPDM (Ethylene Propylene Diene Monomer), and/or TPE (Thermoplastic Elastomer) gasket around the perimeter of the lid to create an airtight seal when closed. The closure mechanism may employ snap latches, threaded connections, or compression clasps to secure the lid firmly against the gasket, ensuring the internal environment remains isolated from external conditions.

For models featuring a base designed to fit in standard vehicle cup holders, the base diameter may range from approximately 65 mm to 85 mm to accommodate the most common cup holder dimensions found in vehicles. The base may include anti-vibration features such as rubberized rings or pads made from TPE or silicone materials to absorb shocks and prevent rattling during transit. These anti-vibration elements may be co-molded with the base or attached as separate components.

The transparent viewing window may be constructed from clear polycarbonate, acrylic, or similar transparent polymers with a thickness of approximately 2 mm to 3 mm. These materials may provide the necessary clarity for visual inspection while maintaining impact resistance comparable to the main body. The window may be either insert-molded during the manufacturing process or secured using ultrasonic welding, adhesives, or mechanical fasteners to ensure a watertight seal with the container body.

For containers incorporating electronic components such as digital hygrometers, humidity sensors, or LED indicators, a small printed circuit board (PCB) may be housed within a sealed compartment in the container wall or lid. The electronic components may be sealed against moisture using conformal coatings or potting compounds to help ensure reliability in humid conditions.

The interior surfaces of the container may be coated with a non-toxic, anti-microbial layer composed of materials such as silver nanoparticles, quaternary ammonium compounds, or similar FDA-approved antimicrobial agents embedded in a polymer matrix. This coating may be applied through spray deposition, dip coating, or in-mold decoration techniques to ensure comprehensive coverage and adhesion to the substrate. The thickness of this coating may range from approximately 10 to 50 microns, providing effective antimicrobial properties without significantly affecting the interior dimensions of the container.

The container may also incorporate hardware for external attachment options, such as D-rings, webbing loops, or MOLLE-compatible attachments molded into or secured to the exterior of the container. These attachment points may be constructed from high-strength polymers or metal components such as stainless steel or aluminum alloys to provide secure connection points for straps, carabiners, or other accessories. The breaking strength of these attachment points may range from approximately 50N to 200N, depending on their intended use and location on the container.

For containers with removable storage cups designed to fit in vehicle cup holders, the cup may be constructed from the same polymer materials as the main container or from insulating materials such as expanded polypropylene (EPP) or vacuum-insulated stainless steel for temperature maintenance of contained liquids. The connection between the removable cup and the main container body may utilize threaded fittings, bayonet mounts, or snap-fit mechanisms to ensure secure attachment during transport while allowing easy removal when needed.

The hardware components described above may work in concert to provide a comprehensive solution for the storage and preservation of diaphragm mouth calls across various operating environments. The selection of specific materials, dimensions, and design features may be tailored to the particular requirements of different user groups, from casual hunters to professional competitive callers, ensuring that the container meets the needs of its intended audience while maintaining the core functionality of humidity control and adjustable positioning.

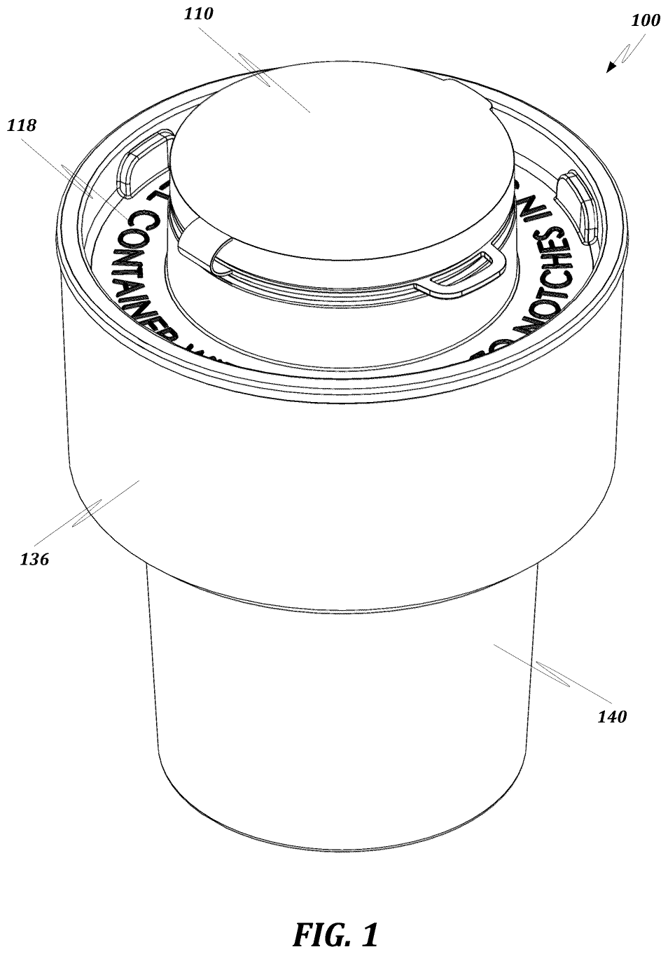

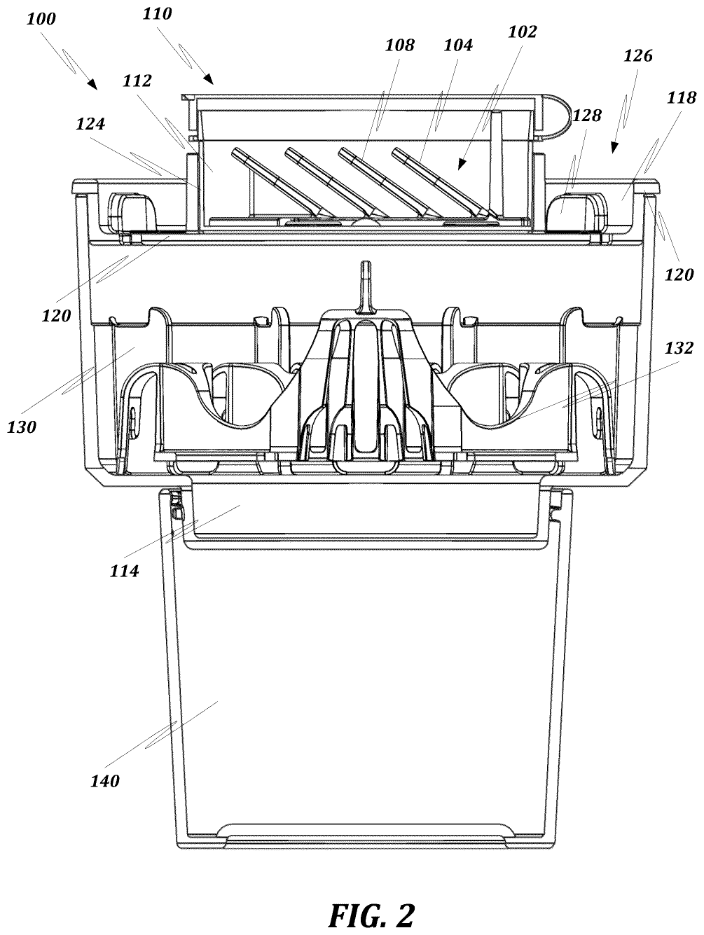

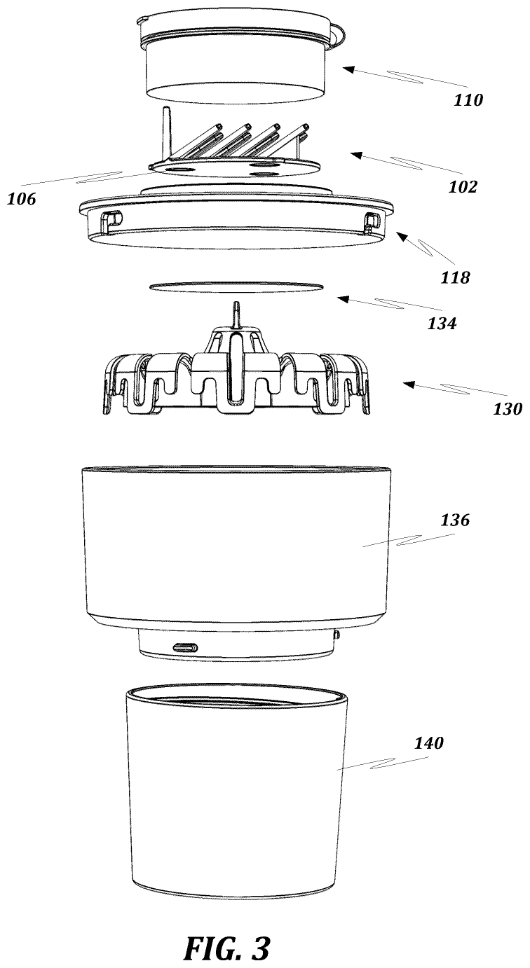

As shown in FIGS. 1-3, the container 100 for storing diaphragm mouth calls with humidity control and adjustable positioning system may be designed with a modular approach, incorporating several distinct functional modules that work together to create an effective storage and preservation environment. Each module may serve a specific purpose while contributing to the overall functionality of the container.

### A. A Reed Holder

The container 100 may include a reed holder module 102. The reed holder module 102 may serve as the primary interface between the diaphragm mouth calls and the container 100. This module 102 may be designed to hold individual diaphragm mouth calls in fixed positions while allowing for customized arrangement based on user preferences.

The reed holder 102 may feature a series of recessed compartments or platforms 104 dimensioned to accommodate standard diaphragm mouth call sizes. These compartments may be arranged in a pattern that maximizes space efficiency while ensuring each call remains separate from others to prevent contact damage. The dimensions of each compartment may be suitable for most commercially available diaphragm mouth calls. In some embodiments, different compartments may be sized differently to accommodate varying sizes of diaphragm mouth calls. As a non-limiting example, one or more of the compartments may be approximately 40 mm in diameter with a depth of 5-10 mm.

The underside of the reed holder 102 may incorporate one or more ferromagnetic elements or metal plates 106 that interact with a magnetic plate 134 in the container. This design may allow the entire reed holder module 102 to be securely positioned within the container while remaining easily removable for access to the calls. The magnetic attraction may be calibrated to provide sufficient holding force to prevent movement during transport without requiring excessive force for removal.

The reed holder 102 may include a surface 108 configured to contact the diaphragm mouth calls. The surface 108 may be lined with or otherwise formed from one or more soft, non-abrasive materials such as microfiber, silicone, EVA foam, and/or the like. This lining 108 may help to prevent or reduce scratches or damage to the delicate reed structures while also providing additional cushioning against impacts. In embodiments, the lining 108 may be approximately 1-2 mm thick and may be permanently bonded to the reed holder 102.

In some embodiments, the reed holder 102 may incorporate identification indicia, such as numbered compartments or customizable label areas. These features may help users organize their collection of calls and quickly identify specific calls without needing to remove them from the holder. The labeling system may utilize either permanent markings molded into the holder or replaceable label inserts that can be updated as the user's collection changes.

For enhanced versatility, the reed holder 102 may optionally be designed with a modular internal structure that allows for reconfiguration based on the specific dimensions of different call types. This may be achieved through removable dividers, adjustable compartment walls, and/or the like that may be positioned to accommodate calls of varying sizes. The adjustment mechanisms may utilize simple snap-fit connections or sliding tracks that can be manipulated without tools.

The materials used in construction of the reed holder 102 may be selected for their dimensional stability and resistance to moisture. As some non-limiting examples, high-density polyethylene, polypropylene, and/or ABS plastic may be suitable choices, as they maintain their shape when exposed to varying humidity levels. In some embodiments, the holder 102 may be manufactured using injection molding processes to ensure consistent quality and precise dimensions. Alternatively, the holder 102 may be manufactured through additive manufacturing processes, such as 3-D printing.

### B. A Reed Container

The container 100 may include a reed container module 110. The reed container module 110 may serve as the main body of the storage system 100, providing the primary enclosure for the diaphragm mouth calls and other components (e.g., the reed tray 130). This dule 110 may establish the overall structure and define the internal environment in which the calls are stored.

The reed container 110 may be constructed from high-impact resistant polymer materials selected for their durability and moisture resistance. The walls of the container 110 may be approximately 3-5 mm thick to provide structural rigidity while maintaining a lightweight profile. The interior dimensions may be defined to accommodate the reed holder module 102 and any calls stored therein with minimal wasted space. As one example, the reed container 110 may define a cavity measuring approximately 100-200 mm in diameter and 50-80 mm in height, depending on the capacity requirements.

The interior surfaces of the reed container 110 may be coated with an antimicrobial layer to help reduce or prevent the growth of mold and/or bacteria. The coating may be applied during the manufacturing process and may utilize, for example, silver ions, quaternary ammonium compounds, and/or similar antimicrobial agents that are safe for items that contact the mouth. The coating may be bonded to the polymer substrate to ensure long-term effectiveness without leaching or degradation.

The reed container 110 may incorporate integrated channels or mounting points for positioning system components (e.g., the reed holder 102). These features may allow for the secure attachment and/or adjustment of platforms, dividers, and/or other organizational elements while maintaining the flexibility to reconfigure the interior layout. The mounting system may utilize standardized dimensions to ensure compatibility across different container models or accessory options.

For moisture control, the reed container 110 may include one or more designated compartments or recesses 112 designed to house moisture-retaining component(s) 114. These areas 112 may be positioned within the container to optimize or otherwise improve humidity distribution while preventing direct contact between the moisture source 114 and the diaphragm mouth calls. The compartments 112 may include drainage channels or ventilation features to manage excess moisture and prevent pooling.

In some embodiments, the exterior of the reed container 110 may feature textured surfaces or grip areas to enhance handling and reduce the risk of dropping. These elements may be integrated into the container design through surface texturing during the molding process, and/or through the application of non-slip materials such as TPE overmolding in specific areas. The texture pattern or other grip features may allow for secure gripping even when the container is wet and/or when the user is wearing gloves.

The reed container 110 may incorporate external attachment points 116 for accessories or for securing the container during transport. The attachment points 116 may include molded-in loops, slots for straps, compatible mounting features for integration with existing gear systems, and/or the like. The attachment points 116 may be reinforced to withstand the expected loads. In some embodiments, the attachment points 116 may be positioned to maintain balance when the container is carried or suspended.

### C. A Sealing Lid

The container 100 may include a sealing lid 118. Sealing Lid 118 may provide secure closure for the container 100 while contributing to the maintenance of the internal humidity environment. The lid 118 may incorporate functional elements that enhance the container's utility and preservation capabilities.

The sealing lid 118 may be constructed from similar materials as the reed container 110, such as high-impact resistant polymers to help ensure material compatibility and consistent performance. The lid 118 may include reinforcing ribs or contours to enhance rigidity and help to prevent warping, which could compromise seal integrity. The thickness of the lid 118 may vary from approximately 2 mm in non-critical areas to 5 mm in areas subject to stress or requiring additional strength.

A gasket 120 may be integrated into the sealing lid 118 to create an airtight seal when closed. This gasket 120 may be composed of EPDM rubber, silicone, and/or similar elastomeric materials with appropriate compression recovery properties. The gasket 120 may be co-molded with the lid 118 or installed as a separate component in a channel designed to hold the gasket securely in place. The gasket 120 may be designed with a specific cross-sectional profile to optimize sealing when compressed against the mating surface of the Reed Container.

The sealing lid 118 may optionally incorporate one or more transparent sections or viewing windows 122 that allow users to monitor the contents without opening the container. These windows 122 may be constructed from clear polycarbonate or acrylic materials. The windows 122 may be permanently bonded to the lid structure. For example, the windows 122 may be affixed to other portions of the lid 118 using ultrasonic welding, adhesives, and/or mechanical fastening methods that maintain the airtight integrity of the assembly. Alternatively, the entirety of the lid 118 may be formed from the transparent material, acting as one large window 122.

The sealing lid 118 may include an integrated holder or attachment point 124 for the reed holder module 102. The holder 124 may utilize the same magnetic securing principles as the reed holder module 102.

The sealing lid 118 may also house components of a moisture control system 126, such as adjustable vents 128 that regulate airflow and humidity levels. These vents 128 may be designed as rotating dials or sliding mechanisms that can be manipulated from the exterior of the container 100. The vent openings 128 may be protected by fine mesh screens to prevent dust or debris from entering while allowing moisture vapor to pass therethrough.

The closure mechanism for securing the sealing lid 118 to the reed container 110 may utilize latches, clasps, threaded connections, a friction fit, and/or any other mechanism that provides sufficient compression force to ensure an effective seal. The mechanism may be designed for easy operation with one hand while wearing gloves, with ergonomic considerations for users with limited dexterity.

### D. A Reed Tray

The reed tray module 130 may provide organized storage for multiple diaphragm mouth calls within the container 100. This module 130 may be designed to fit within the reed container 110 and may offer a systematic approach to arranging and accessing the calls.

The reed tray 130 may be constructed as a single-piece molded component with multiple compartments or divisions 132 specifically sized for diaphragm mouth calls. The tray 130 may be designed to hold up to eight calls, as indicated in the drawings, though designs having more or fewer compartments are also contemplated within the scope of this invention. Each compartment 132 may be sized to receive and retain a mouth call. As one example, each compartment may measure approximately 35-45 mm in diameter to accommodate standard call sizes. The compartments 132 may be arranged in a grid pattern, a circular pattern, a honeycomb pattern, concentric circles, and/or the like, depending on the overall shape of the container.

The depth of each compartment 132 in the reed tray 130 may be selected to hold the diaphragm mouth calls securely while allowing for easy removal. As a non-limiting example, a depth of approximately 10-15 mm may be sufficient to contain the calls without requiring excessive force for extraction. The bottom surface of each compartment 132 may be slightly curved or contoured to match the shape of the calls, providing additional stability and helping to prevent unwanted movement of the calls relative to the tray 130.

The reed tray 130 may be designed to interact with the container's positioning system, allowing it to be placed at various heights relative to the moisture source. For enhanced organization, the reed tray 130 may include identification features for each compartment 132. These may be molded-in numbers, symbols, or color-coding that helps users establish and maintain a consistent storage system for their collection. The identification system may be supplemented with a small card or chart that allows users to record which call is stored in each position.

The materials selected for the reed tray 130 may prioritize moisture resistance and dimensional stability. These materials may maintain their shape and dimensions even when exposed to varying humidity levels, helping to ensure that the tray 130 continues to fit properly within the container 100 and the compartments 132 remain appropriately sized for the calls.

The reed tray 130 may be designed with handling features such as finger recesses, grip areas, or small handles that facilitate easy removal from the container 100. These features may be integrated into the tray design without compromising its space efficiency or interfering with the storage compartments. The handling features may be positioned to allow the tray 130 to be lifted evenly, preventing tilting that could cause calls to fall out of their compartments.

For models designed with magnetic securing systems, the reed tray 130 may incorporate ferromagnetic elements that interact with the magnetic plate 134 in the container 100. This magnetic connection may help keep the tray in position during transport while still allowing for easy removal when access is needed. The magnetic elements may be encapsulated within the tray 130 to prevent direct contact with the diaphragm mouth calls.

### E. A Cleaning Solution Cup

The cleaning solution cup module 136 may provide dedicated storage for cleaning agents or maintenance solutions used to care for diaphragm mouth calls. This module 136 may be designed to contain liquids securely while remaining easily accessible when needed.

The cleaning solution cup 136 may be constructed from liquid-tight materials such as polypropylene, polyethylene, or similar polymers with excellent chemical resistance. The cup may feature walls dimensioned to provide adequate strength while maintaining a lightweight profile. As one non-limiting example, the walls may have a thickness in the range of approximately 1.5-2 mm. The capacity of the cup 136 may be sufficient for storing enough cleaning solution for multiple applications without requiring frequent refilling.

An upper rim of the cleaning solution cup 136 may incorporate a sealing feature to prevent leakage when the container is in motion. This may be achieved through a threaded cap with an integrated gasket, a snap-on lid with a compression seal, or a plug-type closure that fits securely into the opening. The sealing mechanism may be designed to withstand the pressure changes that can occur during air travel or when used in varying elevations.

The exterior of the cleaning solution cup 136 may include texture patterns or grip features that facilitate handling even when wet. These elements may be molded directly into the cup surface or may be applied as separate components such as silicone bands or TPE overmolding. The grip features may be particularly important for users who need to access the cleaning solution while in field conditions and/or while wearing gloves.

In some embodiments, the cleaning solution cup 136 may include measurement markings that allow users to mix cleaning solutions in specific ratios. These markings may be molded into the cup material and/or applied as permanent graphics.

The materials used for the cleaning solution cup 136 may be selected for their compatibility with common cleaning agents used for diaphragm mouth calls. The cup may be resistant to alcohol-based solutions, mild acids, and other cleaning compounds without degradation, discoloration, or leaching of plasticizers. The materials may also be selected for their ability to withstand repeated cleaning without developing surface scratches that could harbor bacteria.

### F. A Storage Cup

The storage cup 140 may serve multiple functions within the container system. For example, the cup 140 may provide additional storage space for accessories, and a means of securing the container 100 in vehicle cup holders during transport. This cup 140 may be designed for versatility and convenience in field conditions.

The storage cup 140 may be constructed from durable polymers such as (but not limited to) high-density polyethylene, polypropylene, or ABS, selected for their impact resistance and dimensional stability. The cup 140 may feature a tapered design dimensioned to fit standard vehicle cup holders. The wall thickness may be selected to provide adequate strength while maintaining a lightweight profile.

The exterior surface of the storage cup 140 may optionally incorporate anti-slip features such as rubber rings, textured patterns, and/or TPE overmolding to enhance stability when placed in cup holders of varying sizes. These features may help prevent the container 100 from shifting or tipping during vehicle movement, particularly on rough terrain or during sudden stops. In some embodiments, the anti-slip elements may be positioned in bands around the cup's circumference, concentrated near the base where contact with the cup holder is most critical. Additionally or alternatively, anti-slip elements may be disposed on the lower surface of the cup 140.

The interior of the storage cup may optionally include compartments or dividers to organize small accessories related to diaphragm mouth calls, such as spare reeds, reed tools, call lanyards, and/or the like. These organizational features may be molded as part of the cup structure or may be implemented as removable inserts that can be configured based on user preferences. The compartments may be sized to accommodate common accessories while maximizing the available space.

The materials selected for the storage cup 140 may be compatible with food and beverages, allowing the cup to serve as a drinking vessel if needed or desired in field conditions. The materials may comply with FDA regulations for food contact and may be free from BPA, phthalates, or other compounds of concern. This food-grade construction may provide additional utility beyond the primary function of equipment storage.

The storage cup 140 may optionally incorporate insulating properties to maintain the temperature of beverages when used as a conventional cup. This functionality may be achieved through double-wall construction, foam insulation layers, and/or the use of materials with naturally low thermal conductivity. The insulating features may be particularly valuable during extended hunting trips or outdoor activities where maintaining beverage temperature is desired.

### Platform Configuration

The container 100 for storing diaphragm mouth calls with humidity control and adjustable positioning system may be configured in various ways to accommodate different user needs, environmental conditions, and usage scenarios. The platform configuration may establish the fundamental architecture of the container system 100, defining how the various modules interact and function together.

The primary configuration of the container may feature a vertically stacked arrangement of components as illustrated in FIGS. 1-3. In this configuration, the storage cup 140 may form the base of the assembly, providing stability and cup holder compatibility. The cleaning solution cup 136 may be positioned directly above, forming the main body and enclosure for the system. The reed tray 130 may be arranged within the cleaning solution cup 136, with the sealing lid 118 disposed on the top opening of the cleaning solution cup. The portable reed container 110 may be attached to an upper side of the sealing lid 118, with the reed holder 102 disposed therein, completing the assembly of the system 100.

The connection between the Storage Cup 140 and the cleaning solution cup 136 may utilize, as non-limiting examples, a threaded interface, bayonet mount, friction fit, etc. that allows for secure attachment while enabling quick detachment when needed. This connection may be designed with O-ring seals or gaskets to prevent moisture transfer between the components, maintaining the controlled humidity environment within the cleaning solution cup 136 even when the storage cup 140 may be exposed to varying external conditions.

The reed container 110 may be configured with internal mounting features such as rails, slots, or support ledges that establish the positions for the reed holder 102 and/or other internal components. These mounting features may be designed to allow for vertical adjustment, enabling users to position the reed holder 102 at various heights relative to the moisture-retaining component. The adjustment increments may be approximately 5-10 mm, providing fine control over humidity exposure.

The magnetic securing system may be configured as a plate positioned at the base of the reed container 110, directly above the connection to the cleaning solution cup 136. This magnetic plate 134 may establish a horizontal reference plane for the positioning system, with the adjustable platforms or dividers extending upward from this base. The magnetic elements may be arranged in a pattern that corresponds to the standard positions of diaphragm mouth calls when placed in the Reed Holder or Reed Tray.

The moisture control system may be configured with the moisture-retaining component positioned at the bottom of the reed container 110, establishing a vertical humidity gradient within the enclosure. This configuration may allow for natural convection currents to distribute moisture throughout the container, with higher humidity levels near the base gradually decreasing toward the top. The adjustable positioning system may take advantage of this gradient by allowing calls to be placed at specific heights corresponding to desired humidity levels.

For users who require precise humidity monitoring, the container may be configured with a hygrometer positioned within the viewing window of the Sealing Lid. This configuration may allow for quick visual confirmation of internal conditions without opening the container. The hygrometer may be positioned at a height representative of the average conditions within the enclosure or may be adjustable to monitor conditions at specific levels within the container.

The container for storing diaphragm mouth calls with humidity control and adjustable positioning system may be designed to integrate seamlessly with other hunting equipment and systems, enhancing its utility in field conditions and complementing existing gear. This integration may take various forms, addressing different aspects of compatibility, attachment, and functional coordination with the broader ecosystem of hunting equipment.

MOLLE compatibility may represent a fundamental integration approach, allowing the container to attach directly to tactical vests, backpacks, or other gear featuring Modular Lightweight Load-carrying Equipment webbing. This integration may utilize standard MOLLE attachment straps or clips on the exterior of the container, positioned to provide secure connection while maintaining accessibility. The attachment points may be designed to distribute the container's weight evenly when connected to larger gear systems, preventing shifting or bouncing during movement. This MOLLE integration may enable hunters to position the call container at their preferred location within their overall equipment setup, such as at chest level for quick access or on a pack for storage during longer movements.

Vehicle mounting systems may provide secure transport and accessibility during travel to hunting locations. The container may incorporate attachment points compatible with standard vehicle accessories such as seat-back organizers, headrest mounts, or dashboard brackets. These vehicle integration features may secure the container against movement during transit while positioning it for convenient access when needed. For hunters who operate from vehicles or use them as base camps, this integration may ensure calls remain properly stored until required in the field.

Wearable system integration may allow the container to be carried directly on the hunter's body for immediate access. This approach may include lanyard and/or belt attachment points, shoulder harness compatibility, or chest rig mounting options that position the container within easy reach during active hunting. The wearable integration features may be designed for one-handed operation, allowing hunters to access calls without removing their eyes from the field or disrupting their shooting position. This body-worn configuration may be particularly valuable for run-and-gun hunting styles or when calling sequences require frequent changes between different call types.

### III. PLATFORM OPERATION

Embodiments of the present disclosure provide device operative by a set of methods. The following depicts an example of at least one method of a plurality of methods that may be performed using the device. Although the method may be described as being performed by a single device, it should be understood that, in some embodiments, different operations may be performed by different devices in operative communication with one another.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

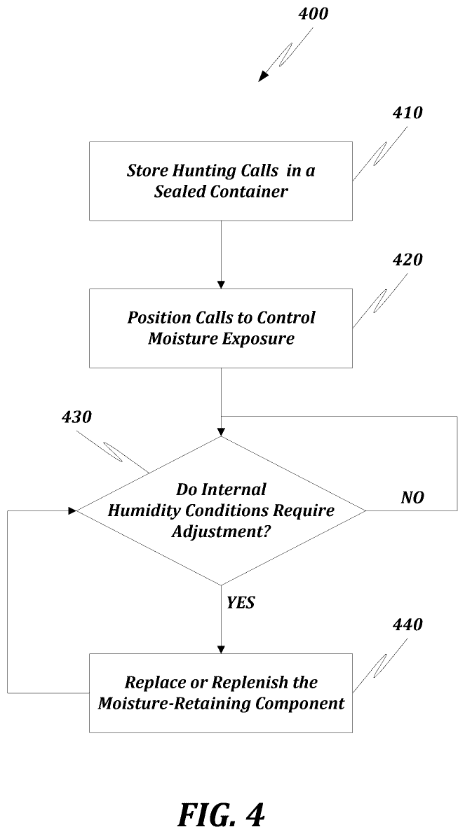

Consistent with embodiments of the present disclosure, FIG. 4 illustrates a method 400 which may be performed by at least one of the aforementioned modules. In accordance with one method 400 for using the container 100, the container 100 for storing diaphragm mouth calls with humidity control and adjustable positioning system may be utilized through a process that optimizes or otherwise improves the preservation of these specialized hunting tools. The method 400 may involve distinct stages that work together to maintain the calls in optimal condition and/or to reduce or prevent degradation of the calls.

At stage 410, hunting calls may be stored in a sealed container that includes a moisture-retaining liquid. This initial stage may involve placing the diaphragm mouth calls within the container 100, which may be designed specifically to create and maintain an appropriate humidity environment. The moisture-retaining component 114 housed within the container 100 may release humidity at a controlled rate to prevent the calls from drying out and becoming brittle or cracking. The moisture-retaining component 114 may comprise a liquid, gel, pad, foam, or similar material formulated to maintain a predetermined humidity level inside the container 100.

The moisture-retaining component 114 may be housed in a designated section 112 of the container 100. This component 114 may be formulated with antimicrobial properties to reduce or prevent the growth of mold and bacteria, which could otherwise develop in the humid environment and potentially harm the calls or pose health risks to users who place these calls in their mouths.

The calls may be positioned to control moisture exposure at stage 420. This stage may involve utilizing the adjustable positioning system within the container 100 to place the diaphragm mouth calls at various distances from the moisture source. The positioning system may allow for customization of the humidity exposure for each individual call based on its specific preservation requirements.

In an example embodiment, a user may utilize the reed holder 102 with its magnetic securing system to position calls at different heights relative to the moisture-retaining component 114. The magnetic plate 106 may secure the calls in fixed positions, preventing unwanted movement that could lead to damage. A non-magnetic barrier layer 108 may prevent direct contact between the calls and the magnetic surface, protecting the integrity of the calls.

The adjustable positioning system may include elevated platforms that can be configured to hold calls at various heights above the moisture source. This vertical adjustment capability may create different humidity zones within the container 100, allowing calls with different moisture requirements to be stored optimally within the same container. For calls requiring higher humidity levels, positioning closer to the moisture source may be preferred, while calls requiring lower humidity may be placed at a greater distance.

The method may also involve periodic monitoring of the internal humidity conditions (e.g., via the viewing window 122) at stage 430. This monitoring may allow users to make adjustments to the positioning of calls or to the airflow vents 128 as needed to maintain optimal preservation conditions. The adjustable airflow vents 128 may regulate the rate of moisture distribution throughout the container 100, providing another means of controlling the humidity exposure of the stored calls.

In some embodiments, the method may include replacing or replenishing the moisture-retaining component 114 at stage 440 when indicated by visual cues or hygrometer readings. The replaceable nature of this component may ensure the long-term effectiveness of the humidity control system, allowing for continued preservation of the diaphragm mouth calls over extended periods.

In practice, the method may be adapted based on specific environmental conditions and user preferences. For instance, in extremely dry environments, users may position calls closer to the moisture source and adjust the airflow vents 128 to increase humidity distribution. Conversely, in humid environments, positioning calls further from the moisture source and increasing airflow may help prevent excessive moisture accumulation that could promote mold growth.

Through this method of storing and positioning diaphragm mouth calls within a specialized container with humidity control features, users may significantly extend the lifespan and maintain the performance characteristics of these hunting tools. The combination of proper storage, controlled humidity, and customizable positioning may ensure that the calls remain in optimal condition and ready for use whenever needed.

### IV. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A container for storing diaphragm mouth calls, comprising:
a body having an internal cavity configured to enclose one or more diaphragm mouth calls;
a moisture control system integrated within the body, the moisture control system comprising a moisture-retaining component and a plurality of adjustable airflow vents; and
a magnetic securing system within the body, the magnetic securing system comprising a magnetic plate configured to secure the diaphragm mouth calls in position.

2. The container of claim 1, wherein the moisture-retaining component comprises a replaceable moisture pad impregnated with antimicrobial agents to prevent growth of mold and bacteria.

3. The container of claim 1, wherein the magnetic plate comprises multiple magnetic zones of varying magnetic strengths, configured to accommodate diaphragm mouth calls of different sizes and weights.

4. The container of claim 1, wherein the adjustable airflow vents are operable from the exterior of the container and include filters to prevent ingress of dust and particulate matter.

5. The container of claim 1, further comprising a transparent viewing window and a hygrometer visible therethrough, enabling monitoring of internal humidity levels without opening the container.

6. The container of claim 1, further comprising an ergonomic handle integrated into the upper portion of the container, the handle being contoured to fit a natural grip of a user's hand and coated with a non-slip material.

7. The container of claim 1, wherein the body comprises a base portion dimensioned to fit within a standard vehicle cup holder, the base portion including anti-vibration features to prevent rattling during transport.

8. A system for storing and preserving diaphragm mouth calls, comprising:
a container body having an internal cavity configured to enclose one or more diaphragm mouth calls;
a humidity regulation subsystem comprising a moisture-retaining component housed within the container body and configured to maintain a predetermined humidity level inside the container body; and
a positioning subsystem within the container body configured to secure the diaphragm mouth calls in multiple positions relative to the moisture-retaining component.

9. The system of claim 8, wherein the positioning subsystem comprises:
a magnetic plate disposed within the container body; and
a plurality of adjustable dividers configured to interact with the magnetic plate to secure the diaphragm mouth calls in various orientations.

10. The system of claim 9, wherein the magnetic plate comprises multiple magnetic zones with varying magnetic strengths to provide differential securing based on size and weight of the diaphragm mouth calls.

11. The system of claim 8, wherein the humidity regulation subsystem further comprises:
a plurality of adjustable airflow vents integrated into walls of the container body; and
a hygrometer visible through a viewing window of the container body to enable monitoring of internal humidity levels without opening the container body.

12. The system of claim 8, further comprising:
a user interface on an exterior surface of the container body, the user interface comprising interactive controls enabling adjustment of internal humidity conditions and configuration of the positioning subsystem without opening the container body.

13. The system of claim 8, wherein the container body comprises:
a base portion dimensioned to fit within a standard vehicle cup holder; and
an ergonomic handle integrated into an upper portion of the container body, the handle being contoured to fit a natural grip of a user's hand.

14. The system of claim 8, wherein the moisture-retaining component comprises replaceable moisture pads impregnated with antimicrobial agents and includes a visual indicator that signals when replacement is needed based on moisture saturation level.

15. A container for storing diaphragm mouth calls, comprising:
a body configured to enclose one or more diaphragm mouth calls;
a moisture-retaining component positioned within the body, wherein the moisture-retaining component comprises a hydrogel formulated to maintain a predetermined humidity level inside the container;
a tiered positioning system within the body, wherein the tiered positioning system comprises multiple vertically arranged platforms configured to hold diaphragm mouth calls at different heights relative to the moisture-retaining component; and
a magnetic securing mechanism integrated into each platform of the tiered positioning system to hold the diaphragm mouth calls in place.

16. The container of claim 15, wherein the tiered positioning system comprises three vertically arranged platforms, with each platform positioned at a different predetermined distance from the moisture-retaining component to create distinct humidity exposure zones within the container.

17. The container of claim 15, wherein the hydrogel is contained within a removable cartridge that includes a visual moisture level indicator visible from the exterior of the container.

18. The container of claim 15, further comprising a rotatable dial integrated into an exterior surface of the body, wherein rotation of the dial adjusts the vertical position of at least one platform of the tiered positioning system.

19. The container of claim 15, wherein the body includes a transparent section positioned to allow visual inspection of the moisture-retaining component without opening the container.

20. The container of claim 15, wherein the magnetic securing mechanism comprises a series of embedded magnets arranged in a pattern that corresponds to standard diaphragm mouth call dimensions.
